(19) United States
(12) Patent Application Publication
(10) Pub. No.: US 2015/0234974 A1
(43) Pub. Date: Aug. 20, 2015

(54) MULTIPLE PATTERNING DESIGN WITH REDUCED COMPLEXITY

(71) Applicants: Samsung Electronics Co., Ltd., Gyeonggi-do (KR); International Business Machines Corporation, Armonk, NY (US)

(72) Inventors: Daniel J. Dechene, Wappingers Falls, NY (US); Sutae Kim, Seoul (KR); Chieh-yu Lin, Ridgefield, CT (US)

(73) Assignees: Samsung Electronics Co., Ltd., Gyeonggi-do (KR); International Business Machines Corporation, Armonk, NY (US)

(21) Appl. No.: 14/181,990

(22) Filed: Feb. 17, 2014

(51) Int. Cl. G06F 17/50

(52) U.S. Cl. CPC G06F 17/5081

(57) ABSTRACT

A three color map can be built based on an integrated circuit (IC) layout, each color representing an exposure in a multiple (here triple) patterning lithography process and can include any combination of additive and/or subtractive exposures. A series of design rules can start with color-specific rules before considering any combination of colors and/or exposures. If the map fails any rule, building the map can be repeated with adjustments and it can be assessed with the design rules.

### BACKGROUND

The invention relates generally to semiconductor structures and fabrication of semiconductor chips and, in particular, to methods of forming complex shapes of components thereof.

An integrated circuit (“IC”) is a device (e.g., a semiconductor device) or electronic system that includes many electronic components, such as transistors, resistors, diodes, etc. These components are often interconnected to form multiple circuit components, such as gates, cells, memory units, arithmetic units, controllers, decoders, etc. An IC includes multiple layers of wiring that interconnect its electronic and circuit components.

Design engineers typically design ICs by transforming logical or circuit descriptions of the ICs' components into geometric descriptions, called design layouts. IC design layouts typically include: (1) circuit modules (i.e., geometric representations of electronic or circuit IC components) with pins, and (2) interconnect lines (i.e., geometric representations of wiring) that connect the pins of the circuit modules. A net is typically defined as a collection of pins that need to be connected. In this fashion, design layouts often describe the behavioral, architectural, functional, and structural attributes of the IC.

To create the design layouts, design engineers typically use electronic design automation (“EDA”) applications. These applications provide sets of computer-based tools for creating, editing, analyzing, and verifying design layouts.

Fabrication foundries (“fabs”) manufacture ICs based on the design layouts using a photolithographic process. Photolithography is an optical printing and fabrication process by which patterns on a photolithographic mask (i.e., photomask) are imaged and defined onto a photosensitive layer coating a substrate. To fabricate an IC, photomasks are created using the IC design layout as a template. The photomasks contain the various geometries (i.e., features) of the IC design layout. The various geometries contained on the photomasks correspond to the various base physical IC elements that comprise functional circuit components such as transistors, interconnect wiring, via pads, as well as other elements that are not functional circuit elements, but that are used to facilitate, enhance, or track various manufacturing processes. Through sequential use of the various photomasks corresponding to a given IC in an IC fabrication process, a large number of material layers of various shapes and thicknesses with various conductive and insulating properties may be built up to form the overall IC and the circuits within the IC design layout.

Constraining factors in traditional photolithographic processes limit their effectiveness as circuit complexity continues to increase and transistor designs become more advanced and ever smaller in size (i.e., die shrink). Some such constraining factors are the lights/optics used within the photolithographic processing systems. Specifically, the lights/optics are band limited due to physical limitations (e.g., wavelength and aperture) of the photolithographic process. Therefore, the photolithographic process cannot print beyond a certain pitch, distance, and other such physical manufacturing constraints.

A pitch specifies a sum of the width of a feature and the space on one side of the feature separating that feature from a neighboring feature. Depending on the photolithographic process at issue, factors such as optics and wavelengths of light or radiation restrict how small the pitch may be made before features can no longer be reliably printed to a wafer or mask. As such, the smallest size of any features that can be created on a wafer is severely limited by the pitch.

With the advance of ultra deep submicron technology, the feature size and feature pitch get so small that existing lithography processes meet their bottleneck in printing the shapes represented by the features. On the other hand, there are difficulties in the practical use of advanced photolithographic processes (e.g., extreme ultra violet (EUV)). Therefore, the current lithography technology is expected to be used for next generation silicon technology. To compensate for the difficulty in printing the shape of small pitches, multiple patterning lithography is recognized as a promising solution for 32 nm, 22 nm, 16 nm, and finer pitches as technology may allow in volume IC production. Multiple patterning lithography technology generally decomposes a single layer of a layout into multiple masks and applies multiple exposures to print the shapes in the layer. The decomposition provided by multiple patterning lithography increases shape printing pitch and improves the depth of focus.

Double patterning lithography is one type of multiple patterning lithography technology that has been in use for some time. Double patterning lithography generally involves placing shapes that are too close to each other to be assigned to the same mask layer, onto two different mask layers in order to satisfy spacing requirements specified in the design layout. These two different mask layers are then used to print one design layer. However, for a dense layer of a layout, the double patterning lithography is not enough to print the shapes of the layer while maintaining the Ml pitch spacing requirements. This gives rise to explore other multiple patterning lithography options such as triple patterning lithography.

### SUMMARY

An embodiment of the invention disclosed herein can take the form of a method, performed on a computing device having at least one processing unit in communication with at least one non-transitory computer readable storage medium, of preparing an integrated circuit (IC) layout design using the at least one processing unit of the computing device. The layout can be received with pattern features in the layout specified as discrete shapes and a multiple color representation of the layout can be built. The multiple color representation can include a combination of a plurality of colors, each color representing a respective exposure. Each discrete shape of the layout can include a subshape in at least one of the colors. The method can include determining whether the multiple color representation of the layout passes a plurality of design rules including at least a minimum space between facing parallel edges of adjacent shapes. Responsive to failure under at least one design rule, the layout can be adjusted and the building of a multiple color representation and the determining whether the multiple color representation passes a plurality of design rules can be repeated.

Another embodiment of the invention disclosed herein can take the form of a computer program product including computer instructions stored on a at least one non-transitory computer readable storage medium, the instructions, when executed by a computing device, configuring the computing device to prepare an integrated circuit (IC) layout design. The layout can be received with pattern features in the layout specified as discrete shapes and a multiple color representation of the layout can be built. The multiple color representation can include a combination of a plurality of colors, and each color can represent a respective exposure. Each discrete shape of the layout can include a subshape in at least one of the colors. The method can include determining whether the multiple color representation of the layout passes a plurality of design rules including at least a minimum space between facing parallel edges of adjacent shapes. Responsive to failure under at least one design rule, the layout can be adjusted and the building of a multiple color representation and the determining whether the multiple color representation passes a plurality of design rules can be repeated.

A further embodiment of the invention disclosed herein can take the form of a system comprising at least one computer processor and at least one non-transitory memory device operably connected to the at least one computer processor, the at least one non-transitory memory device including at least one non-transitory computer readable storage medium, the at least one memory device including computer instructions configured to cause the at least one computer processor to prepare an integrated circuit (IC) layout design. The layout can be received with pattern features in the layout specified as discrete shapes and a multiple color representation of the layout can be built. The multiple color representation can include a combination of a plurality of colors, each color representing a respective exposure. Each discrete shape of the layout can include a subshape in at least one of the colors. The method can include determining whether the multiple color representation of the layout passes a plurality of design rules including at least a minimum space between facing parallel edges of adjacent shapes. Responsive to failure under at least one design rule, the layout can be adjusted and the building of a multiple color representation and the determining whether the multiple color representation passes a plurality of design rules can be repeated.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings.

FIG. 1 is a schematic illustration of a layout that can be prepared according to embodiments of the invention disclosed herein.

FIG. 2 is a schematic illustration of a layout prepared according to embodiments of the invention disclosed herein.

FIG. 3 is a schematic illustration of a precursor to an exposure generated as part of preparing a layout according to embodiments of the invention disclosed herein.

FIG. 4 is a schematic illustration of a precursor to an exposure generated as part of preparing a layout according to embodiments of the invention disclosed herein.

FIG. 5 is a schematic illustration of a precursor to an exposure generated as part of preparing a layout according to embodiments of the invention disclosed herein.

FIG. 6 is a schematic illustration of a layout prepared according to embodiments of the invention disclosed herein.

FIG. 7 is a schematic flow diagram illustrating a method of preparing a layout according to an embodiment of the invention disclosed herein.

FIG. 8 is a schematic block diagram of a general purpose computer system which may be used to practice aspects of embodiments of the invention disclosed herein.

### DETAILED DESCRIPTION

Embodiments of the present invention are directed to a technique that can be used to decompose an integrated circuit (“IC”) design layout for multiple patterning lithography technology. Multiple patterning lithography generally involves placing shapes that are too close to each other to be assigned to the same mask layer, onto multiple different mask layers in order to satisfy spacing requirements specified in the layout, as well as to overcome rounding of vertices that can occur as a result of the relative sizes of wavelengths of radiation used and features of the layout. These different masks can then be used to print one design layer. Thus, given a set of shapes (e.g., polygonal shapes) in a layout, embodiments of the present invention can decompose them into multiple mask layers so that no shapes on the same mask layer violate spacing requirements provided in the design rules of the layout and so that no vertex of the layout is formed by just one shape and/or one mask. In addition to obtaining a feasible solution that facilitates decomposing a given set of shapes in a layout into multiple mask layers without violating spacing requirements, embodiments of the invention disclosed herein can also balance mask density among the mask layers and minimize the number of stitches (i.e., where two touching segments from the same shapes are assigned to different mask layers) while performing the decomposition.

For ease of description, a triple patterning example will be employed in the description that follows, but it should be recognized that aspects of the invention disclosed herein can be used for any number of patterns and/or masks. Thus, in substantially any instance of “triple pattern(ing),” “triple color,” “three pattern,” and/or “three-color(ing),” “triple” and/or “three” generally can be replaced with “multiple” in the scope of embodiments.

Triple patterning layout decomposition can be regarded as a three-coloring problem on a conflict graph. As is known in the art and used hereinafter, a mask layer is often referred to as a “color” and mask layers are referred to as “colors”. Thus, in a three-coloring problem, a triple patterning conflict graph can be used to represent the constraints associated with coloring (i.e., masking) shapes that are too close to each other to be assigned the same color onto three colors. In particular, the triple patterning conflict graph represents color conflicts (i.e., spacing violations) when shapes in the layout are assigned to the same color. More specifically, in a triple patterning conflict graph, nodes can represent the features of the shapes to be colored and conflict arcs that couple some of the nodes in the graph can represent the color conflicts that may exist when shapes represented by these nodes are assigned to the same color. Coloring the triple patterning conflict graph in three colors so that there is no edge connecting two nodes in the same color is equivalent to a three-coloring problem that is recognized as an NP-complete problem, and possibly an NP-hard problem.

Embodiments of the present invention utilize a customized three-coloring algorithm as described herein to obtain a three-color feasible solution for decomposing shapes in a layout into three colors so that none of the shapes on the same mask layer violate spacing requirements. As used herein, “a three-color feasible solution” is a solution that satisfies all of the constraints in the constrained coloring problem of decomposing shapes in a layout into three colors, so that none of the shapes on the same mask layer violate spacing requirements. At the same time, the three-color feasible solution that is provided by the various embodiments of the present invention can also balance color density of the shapes among the three colors and minimize the number of stitches.

The customized three-coloring algorithm described below in more detail generally includes receiving a layout having pattern features specified as polygonal shapes. A triple patterning conflict graph representing the color conflicts that exists between the shapes in the layout is then built. The shapes represented by the triple patterning conflict graph are decomposed into three colors while balancing color density among the three colors and minimizing the number of stitches used to represent the shapes in the layout. If the solution provided by the decomposition is not three-colorable (i.e., there is color conflict), then the shapes in the decomposition that are associated with the color conflict are selectively segmented to resolve the conflict.

Embodiments of the invention provide a method of layout decomposition and/or a set of design rules that can enable simpler, faster decomposition of a layout for preparation of multiple masks for multiple pattern lithography. Three color patterning can be used as in other solutions to simplify conflict checking, but the number of polygons used in each mask layer can be greatly reduced, as can a number of computations required to create the multiple mask layers.

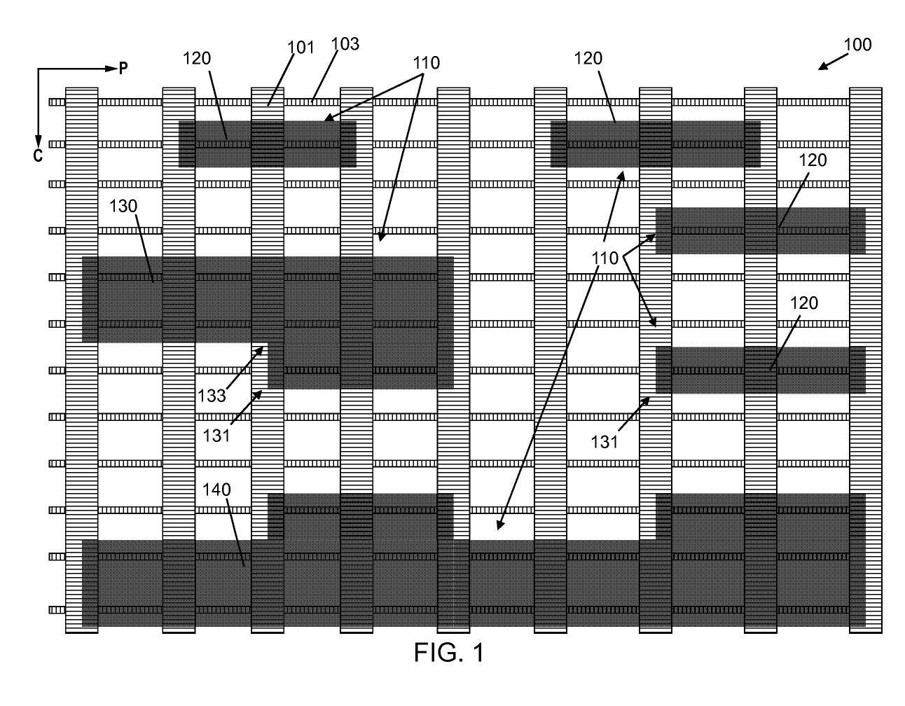

With reference to FIG. 1, a layout 100 with which embodiments of the invention disclosed herein can be used can include and/or be specified as a plurality of discrete shapes 110, such as simple polygons 120, moderately complex compound polygons 130, and complex polygons 140. Shapes 110 can be laid out over a grid of first members 101 extending in a C direction (illustrated by substantially orthogonal P-C axes) substantially orthogonal to second members 103 extending in a P direction. In embodiments, first members 101 can be polysilicon members and second members 103 can be fins, though any other suitable structures can be used if desired. Shapes 110 can include external vertices 131, and moderately complex and complex polygons 130, 140 can also include internal vertices 133, each of which can experience rounding during micro- and/or nanofabrication. Layout 100 can represent components of an integrated circuit (IC) and connections therebetween, each shape 110 representing a component of the IC.

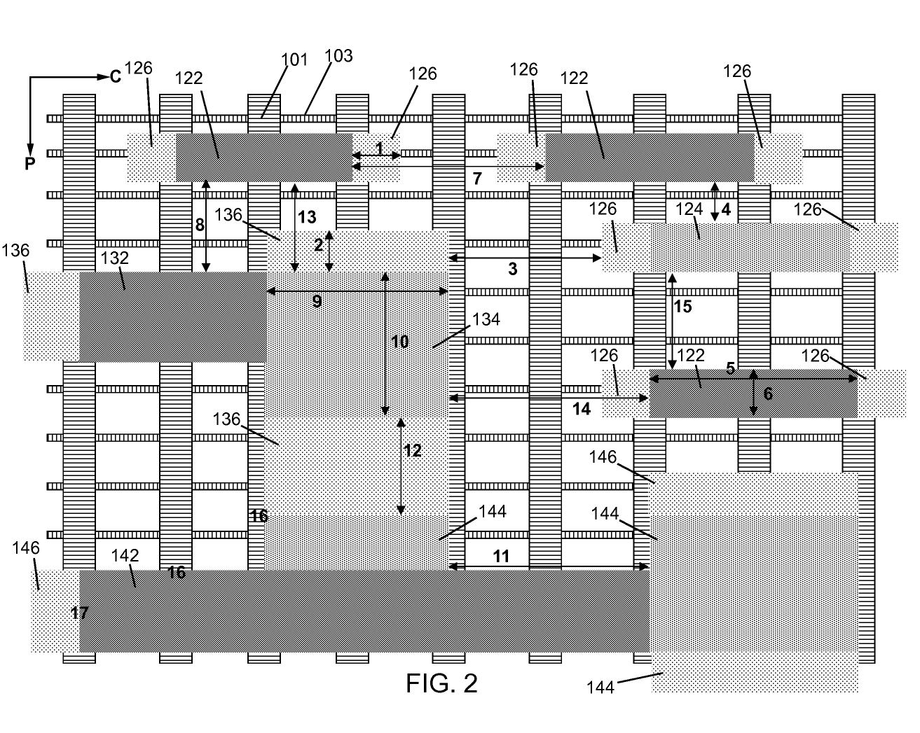

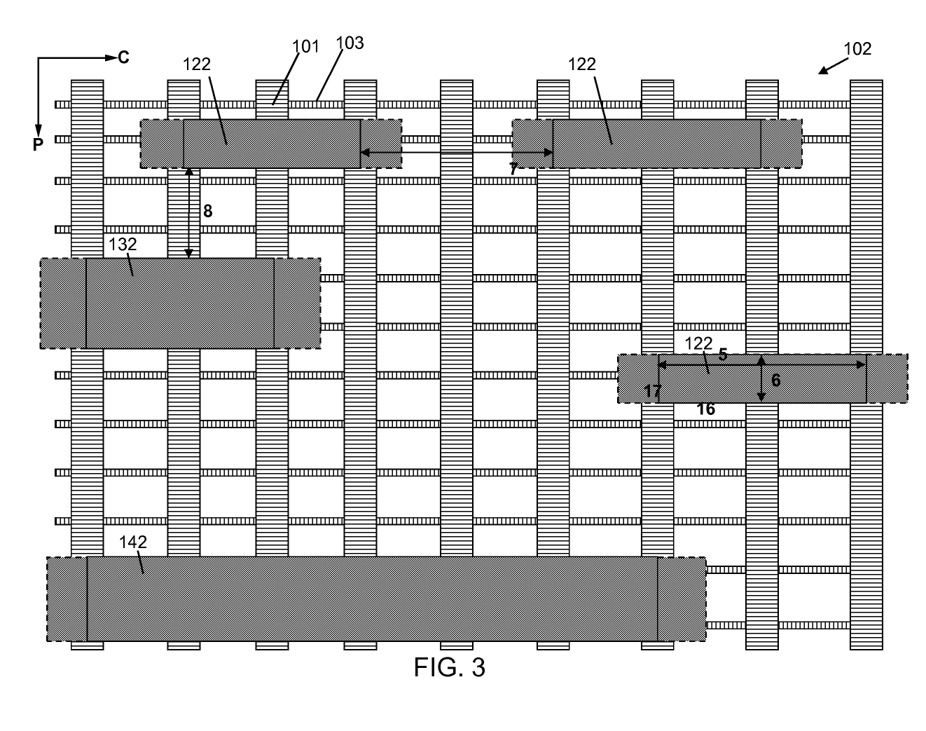

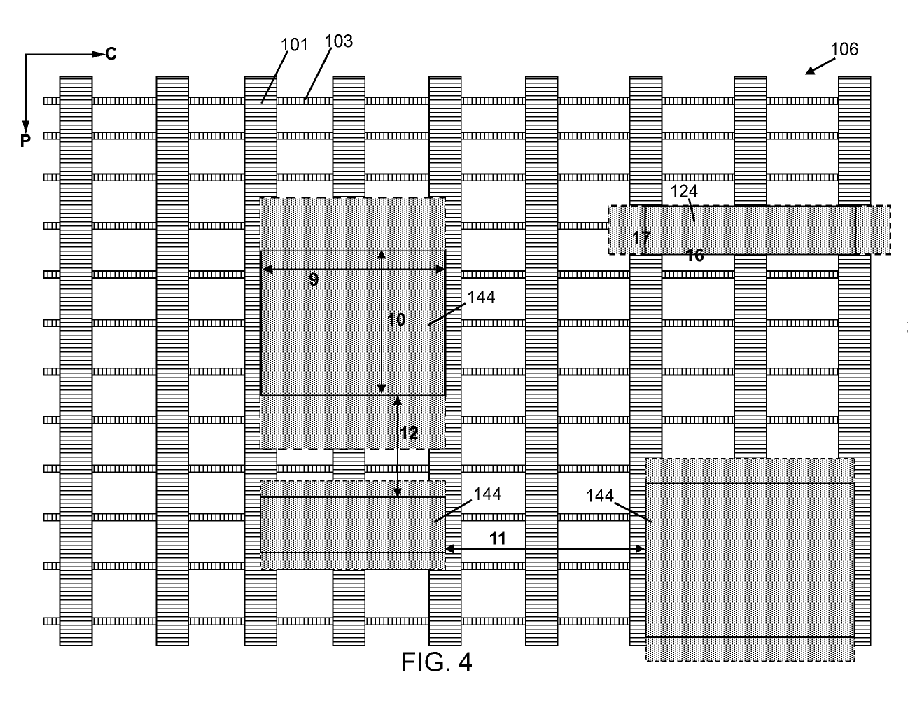

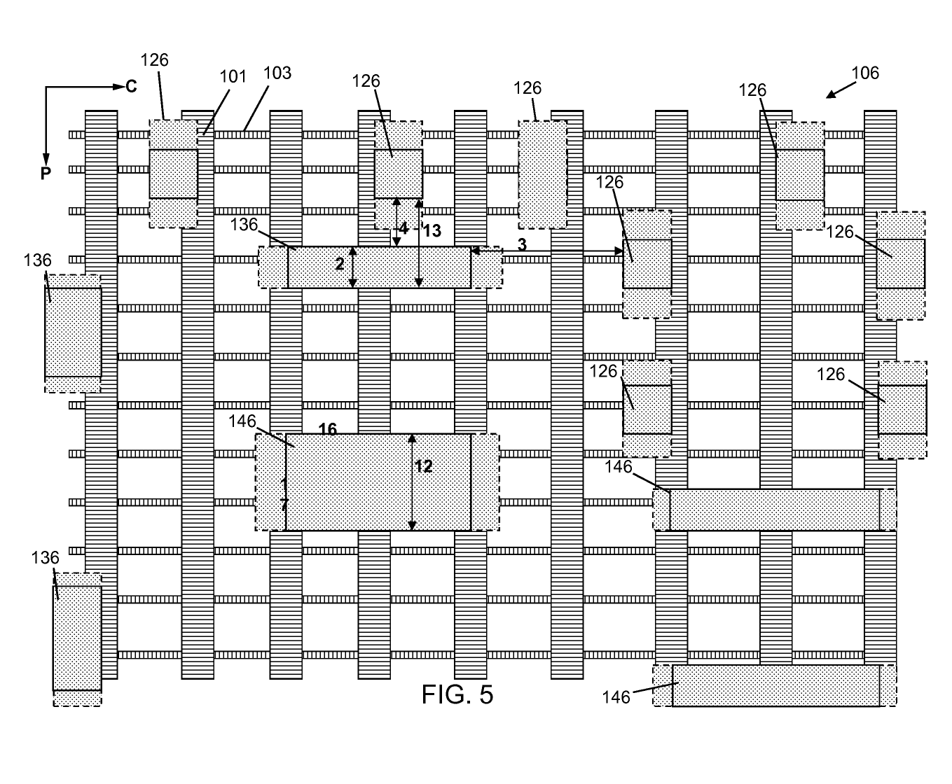

Embodiments can build a three color representation of layout 100, a first color representing a first exposure (102 in FIG. 3), a second color representing a second exposure (104 in FIG. 4), and a third color representing a third exposure (106 in FIG. 5), and each shape including a subshape in at least one of the first, second, and third exposures. In embodiments, third exposure 106 (FIG. 5) can be a final cut mask, which can be subtractive, and first and second exposures 102, 104 (FIGS. 3 and 4) can be additive. Where third exposure 106 is a final cut mask, it is considered first in design rules according to embodiments of the invention disclosed herein before any combination of the exposures is considered. It should also be recognized that FIGS. 2-5 do not represent exposures per se inasmuch as some second and/or third color subshapes in an actual exposure must be elongated to eliminate corner rounding that might be introduced by a first and/or second color subshape.

As seen in FIG. 2, simple polygons 120 can be decomposed into three subshapes: a first color subshape 122, and third color subshapes 126 on either end of first color subshape 122. However, it should be noted that a simple polygon 120 can also be decomposed into a second color subshape 124 with third color subshapes 126 on either end thereof, and/or other combinations of subshapes and/or colors as may be suitable and/or appropriate. Similarly, moderately complex polygon 130 can be decomposed and/or defined by a first color subshape 132, second color subshapes 134, and/or third color subshapes 136, while complex polygon 140 can be decomposed into and/or defined by first color subshape 142, second color subshapes 144, and/or third color subshapes 146. In embodiments, subshapes, particularly third color subshapes 126, 136, 146 where third color 106 is a final cut mask, can be used with multiple shapes 110. For example, as illustrated in FIG. 2 a third color subshape 136 of moderately complex polygon 130 helps to form and/or define both moderately complex polygon 130 and complex polygon 140. FIG. 2 also includes numbered arrows and subshape edges, the numbers representing design rules according to embodiments, as will be explained below.

To further illustrate the relationship between subshapes, each color, which can be construed as a precursor to an exposure, is shown in FIGS. 3-5. More specifically, a first color 102 is shown in FIG. 3 with subshapes 122, 132, 142, a second color 104 is shown in FIG. 4 with subshapes 124, 134, 144, and a third color 106 is shown in FIG. 5 with subshapes 126, 136, 146. In FIGS. 2 and 5, third color subshapes 126, 136, 146 are shown as part of third color 106 being a final cut mask. With appropriate selection of the order in which the colors and/or exposures and/or subshapes are applied, including whether a given exposure will add material or remove material and by extending subshapes of some colors to overlie intersections with subshapes of other colors, external and internal vertices 131, 133 can be formed with rounding substantially eliminated.

With an initial decomposition prepared, embodiments can determine whether the multiple color representation of the layout, three colors in this example, passes a plurality of design rules including at least a minimum space between facing parallel, non-collinear edges of adjacent shapes. As stated above, while the description herein is mostly couched in terms of three color representation, embodiments can be applied to any number of colors and/or exposures. An example of a particular set of design rules according to embodiments of the invention disclosed herein is seen in Table I below. If any design rule is violated, i.e. responsive to failure under at least one design rule, layout 100 can be adjusted, the adjusted layout can be decomposed, and the building of a multiple color map and determining whether the new map passes the plurality of design rules according to embodiments can be repeated.

As seen in FIGS. 2 and 5, final cut subshapes 126, 136, 146 in the example shown should have a minimum width in the C direction (rule 1) and in the P direction (rule 2), and should be separated by a minimum distance in the C direction (rule 3) and in the P direction (rule 4). Note that while arrow 4 in FIG. 2 extends between a first color subshape 122 and a second color subshape 124, the edges of these are substantially the same distance apart as edges of respective third color or final cut mask subshapes 126. Thus, initial design rules 1-4 can be specifically directed to a final cut mask.

A next group of design rules can be directed to first color and/or exposure 102 (FIG. 3). For example, as seen in FIGS. 2 and 3, first color subshapes 122, 132, 142 should have a minimum width in the C direction (rule 5) and a minimum width/height in the P direction (rule 6). In addition, first color subshapes 122, 132, 142 should be separated by a minimum distance in the C direction (rule 7) and in the P direction (rule 8). Second color and/or exposure 104 (FIG. 4) can then be assessed with a third group of deign rules. That is, referring to FIGS. 2 and 4, each second color subshape 124, 134, 144 should have a minimum width in the C direction (rule 9) and in the P direction (rule 10) and there should be a minimum distance between them in the C direction (rule 11) and in the P direction (rule 12).

If none of color- and/or exposure-specific design rules 1-12 has been violated, inter-color and/or -exposure design rules can be applied. For example, as seen in FIG. 2, edges of first color subshapes 122, 132, 142 should not be touching edges of second color subshapes 124, 134, 144 unless they are part of the same shape 110 in the P direction (rule 13) and in the C direction (rule 14). In similar fashion, each first color subshape 122, 132, 142 should be a minimum distance from any second color subshape 124, 134, 144 along a first member 101 unless they are part of the same shape 110 (rule 15).

As seen in FIGS. 2-5, every first color subshape 122, 132, 142 and second color subshape 124, 134, 144 should have P-edges halfway between adjacent second members 103 (rule 16) and C-edges along a centerline of a first member 101 (rule 17). Further, each first color subshape edge extending in the P direction should lie halfway between adjacent second members 103 (rule 16), and each first color subshape edge extending in the C direction should lie along a centerline of a first member 101 (rule 17). Any second color subshape 124, 134, 144 must have an edge coincident with a first color subshape 122, 132, 142 (rule 18), as can be observed in FIG. 2, and every subshape 122, 124, 126, 132, 134, 136, 142, 144, 146 must be an orthogonal rectangle (rule 19). In other words, any pair of subshapes common across colors and/or exposures to one shape of the layout must have a coincident edge under rule 18. Finally, every outer or external vertex 131 must touch a first member 101, unless an external vertex 131 of a subshape is at an inner vertex 133 of the union of subshapes, such as is shown in FIG. 2, into a respective shape 110 (rule 20).

As can be seen from the FIGS., coincident edges of any pair of subshapes in which one subshape is a first color corresponding to a first exposure and another subshape is a second color corresponding to a second exposure indicates that the respective pair of subshapes can require additional process compensation. For example, one of the subshapes can be extended so as to lengthen the corresponding coincident edge. In particular, the respective second color subshape can be extended, the second color representing an exposure applied after that represented by the first color. Likewise, an intersection of edges of any pair of subshapes in which one subshape is a first color and another subshape is a second color indicates that the respective pair of subshapes can require additional process compensation. For example, one of the subshapes can be extended so as to lengthen the corresponding intersecting edge. In particular, the respective second color subshape can be extended, the second color representing an exposure applied after that represented by the first color. An example of such additional process compensation is illustrated by the dashed portions of color subshapes 122, 124, 126, 132, 134, 136, 142, 144, 146 in FIGS. 3-5.

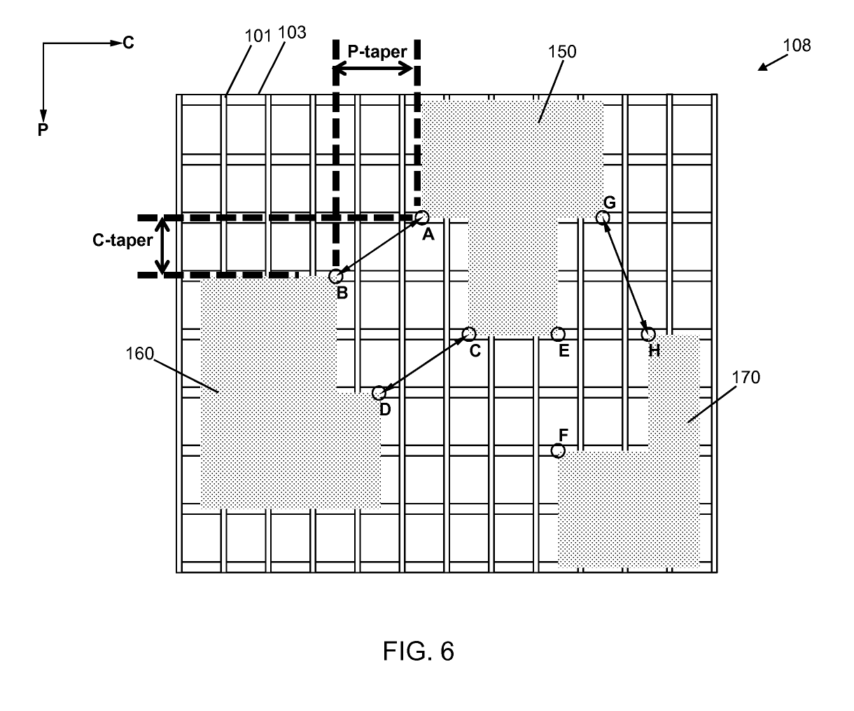

A more detailed illustration of rule 20 can be observed in FIG. 6. As can be seen, a layout 108 can include shapes 150, 160, 170. Each shape can include vertices, some of which can face vertices of an adjacent shape. For example, a first shape 150 can include vertices A, C, E, and G, which can face vertices B, D, F and H, and H, respectively. Vertex pairs on a same shape are not considered. Between any facing vertices A-H in layout 108, a C-taper can be defined in the C direction and a P-taper can defined in the P direction. Each taper must have a minimum value such that there is a minimum distance in each of two orthogonal directions (such as C and P directions) between facing vertices of adjacent shapes, such as vertices A and B of shapes 140 and 130, respectively. Thus, vertex pairs A-B, C-D, and G-H are acceptable, whereas vertex pairs C-E, E-F, and E-H are unacceptable.

The following TABLE I lists design rules that can be used with a three-color layout decomposition according to embodiments of the invention disclosed herein, but it should be understood that the principles illustrated thereby can be extended to any number of colors used in decomposition within the scope of embodiments.

TABLE I
Design Rules

| Number | Description |
|---|---|
| 1 | Third color C-width |
| 2 | Third color P-width |
| 3 | Third color C-space |
| 4 | Third color P-space |
| 5 | First color shape C-width |
| 6 | First color shape P-width |
| 7 | First color shape C-space |
| 8 | First color shape P-space |
| 9 | Second color shape C-width |
| 10 | Second color shape P-width |
| 11 | Second color shape C-space |
| 12 | Second color shape P-space |
| 13 | First color shape to second color shape not touching P-space |
| 14 | First color shape to second color shape not touching C-space |
| 15 | First color shape, second color shape min space to third color not |
| | touching |
| 16 | First color shape, second color shape P-edges must lie on |
| | centerline between second members |
| 17 | First color shape, second color shape C-edges must lie on |
| | centerline of first members |
| 18 | Second color shape MUST have coincident edge first color |
| | shape (enforces use cases) |
| 19 | First color shape, second color shape, third color must be |
| | orthogonal rectangles |
| 20 | Outer vertices of First color shape, second color shape MUST |
| | touch third color except at inner vertex of UNION (first color |
| | shape, second color shape) enforces use cases) |

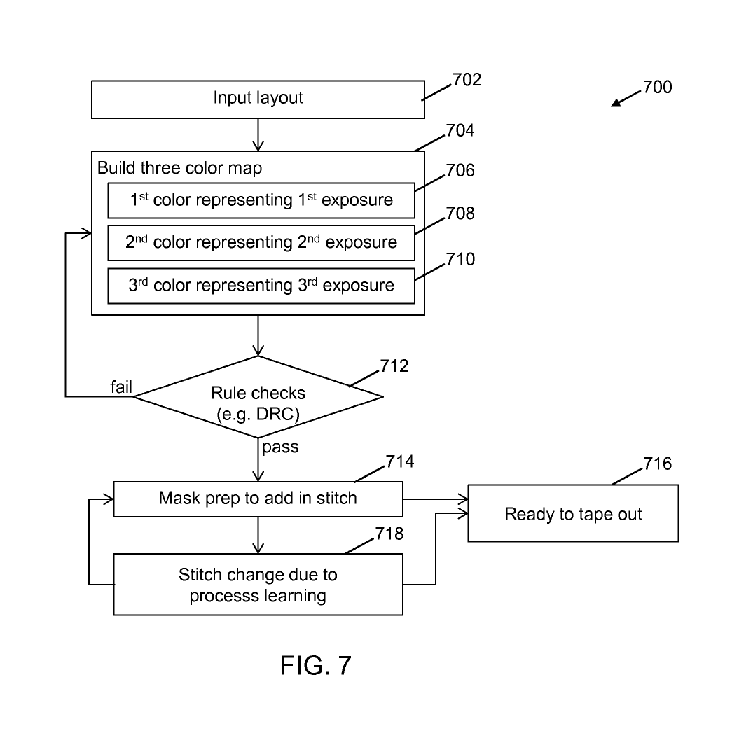

A particular expression of a method 700 according to embodiments of the invention disclosed herein is seen schematically in FIG. 7, particularly with regard to the three-color example described above. Again, however, it should be noted that any number of colors and/or exposures can be used within the scope of embodiments. Returning to the described three-color example, an input layout can be received and/or acquired (block 702) and a three color map can be built (block 704). A first color can represent a first exposure (block 706), a second color can represent a second exposure (block 708), and a third color can represent a third exposure (block 710). Building the three color map can also be referred to as decomposing the layout and/or discrete shapes of the layout. Once the three color map is built, rule checks, such as design rule checks (DRC), can be applied (block 712), such as by using design rules according to embodiments of the invention disclosed herein, examples of which are listed in TABLE I above. If the three color map fails any design rule, a new three color map can be built with adjustments to satisfy the rule the last map failed, and DRC can be applied to the new map (repeat blocks 704-712). When a three color map passes DRC, at least one mask can be prepared (block 714), and the mask(s) can be ready to tape out (block 716). In embodiments, the mask(s) can be evaluated and any stitch change needed due to process learning can be determined (block 718), in which case block 714 can be repeated and can take the change in stitch into account or the mask(s) can be ready to tape out (block 716).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing, such as can be considered non-transitory. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks and/or configure the computer or other programmable data processing apparatus to perform a method and/or functions in accordance with embodiments.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

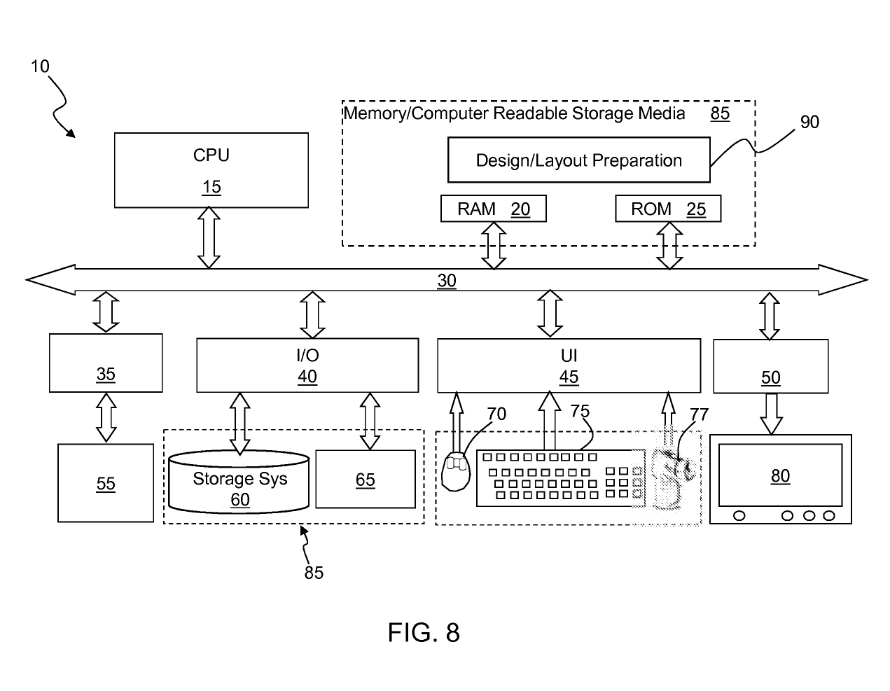

FIG. 8 shows an example of a block diagram of a general-purpose computer system 10 which can be used to implement the method, system, computer program, and/or computer program product described herein. The method, system, computer program, and/or computer program product may be coded as a set of instructions on removable or hard media for use by general-purpose computer, and thus may, in embodiments, include a computer program product. FIG. 1 is also a schematic block diagram of a general-purpose computer for practicing the present invention. Computer system 10 can have at least one microprocessor or central processing unit (CPU) 15. CPU 15 can be interconnected via a system bus 30 to machine readable media 85, which can include, for example, a random access memory (RAM) 20, a read-only memory (ROM) 25, a removable and/or program storage device 65, and/or a mass data and/or program storage device 60. An input/output (I/O) adapter 40 can connect mass storage device 60 and removable storage device 65 to system bus 30. A user interface 45 can connect a keyboard 75 and/or a mouse 70 and/or an image capture device 77, such as a camera, and/or any other suitable input device to system bus 30, and a port adapter 35 can connect a data port 55 to system bus 30 and a display adapter 50 can connect a display device 80. ROM 25 can include the basic operating system for computer system 10. Examples of removable data and/or program storage device 65 include magnetic media such as floppy drives, tape drives, portable flash drives, zip drives, and optical media such as CD ROM or DVD drives. Examples of mass data and/or program storage device 60 include hard disk drives and non-volatile memory such as flash memory. In addition to keyboard 75 and mouse 70, other user input devices such as trackballs, writing tablets, pressure pads, microphones, light pens and position-sensing screen displays may be connected to user interface 45. Examples of display device 80 include cathode-ray tubes (CRT), liquid crystal diode (LCD) displays, light emitting diode (LED) displays, plasma displays, holographic displays, tactile displays, and/or any other display device as may be available, suitable, and/or known now and/or in the future.

A machine readable computer program may be created by one of skill in the art and stored in computer system 10 or a data and/or any one or more of machine readable medium 85, such as in the form of a computer program product 90, to simplify the practicing of this invention. In operation, information for the computer program created to run the present invention can be loaded on the appropriate removable data and/or program storage device 65, fed through data port 55, acquired with image capture device 77, and/or entered using keyboard 75. A user can control the program by manipulating functions performed by the computer program and providing other data inputs via any of the above mentioned data input means. Display device 80 can provide a means for the user to accurately control the computer program and perform the desired tasks described herein.

Computer program product 90 according to embodiments of the invention disclosed herein can be stored in memory and/or computer readable storage media 85, in embodiments. While shown as outside of RAM 20 and ROM 25, it should be readily apparent that computer program product 90 and/or portions thereof can reside in these and/or any other storage medium accessible by computer system 10. It should be noted that CPU(s) 15 can in embodiments be called a computing device(s), but that computer system 10 as a whole, or portions thereof, could also be called a computing device.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, performed on a computing device having at least one processing unit in communication with at least one non-transitory computer readable storage medium, of preparing an integrated circuit (IC) layout design, the method comprising:
using the at least one processing unit of the computing device to:
receive a layout of the layout design with pattern features in the layout specified as discrete shapes;
build a multiple color representation of the layout including a combination of a plurality of colors, each color representing a respective exposure, and each discrete shape of the layout including a subshape in at least one of the colors;
determine whether the multiple color representation of the layout passes a plurality of design rules including at least a minimum space between facing parallel edges of adjacent shapes; and
responsive to failure under at least one design rule, adjust the layout and repeat the building of a multiple color representation and the determining whether the multiple color representation passes a plurality of design rules.

2. The method of claim 1, wherein coincident edges of a pair of subshapes in which one subshape is a first color corresponding to a first exposure and another subshape is a second color corresponding to a second exposure indicates that the respective pair of subshapes requires additional process compensation.

3. The method of claim 2, wherein the additional process compensation includes extending one subshape of the pair of subshapes to lengthen the corresponding coincident edge.

4. The method of claim 3, wherein the second color subshape is extended.

5. The method of claim 1, wherein an intersection of edges of a pair of subshapes in which one subshape is a first color and another subshape is a second color indicates that the respective pair of subshapes requires additional process compensation.

6. The method of claim 5, wherein the additional process compensation includes extending one of the respective subshapes to lengthen the respective intersecting edge.

7. The method of claim 6, wherein the second color subshape is extended.

8. A computer program product including computer instructions stored on a at least one non-transitory computer readable storage medium, the instructions, when executed by a computing device, configuring the computing device to prepare an integrated circuit (IC) layout design by:
receiving a layout of the layout design with pattern features in the layout specified as discrete shapes;
building a multiple color representation of the layout including a combination of a plurality of colors, each color representing a respective exposure, and each discrete shape of the layout including a subshape in at least one of the colors;
determining whether the multiple color representation of the layout passes a plurality of design rules including at least a minimum space between facing vertices of adjacent shapes; and
responsive to failure under at least one design rule, adjusting the layout and repeating the building of a multiple color representation and the determining whether the multiple color representation passes a plurality of design rules.

9. The computer program product of claim 8, wherein coincident edges of a pair of subshapes in which one subshape is a first color corresponding to a first exposure and another subshape is a second color corresponding to a second exposure indicates that the respective pair of subshapes requires additional process compensation.

10. The computer program product of claim 9, wherein the additional process compensation includes extending one of the respective subshapes to lengthen the corresponding coincident edge.

11. The computer program product of claim 10, wherein the second color subshape is extended.

12. The computer program product of claim 8, wherein an intersection of edges of a pair of subshapes in which one subshape is a first color and another subshape is a second color indicates that the respective pair of subshapes requires additional process compensation.

13. The computer program product of claim 12, wherein the additional process compensation includes extending one of the respective subshapes to lengthen the respective intersecting edge.

14. The computer program product of claim 13, wherein the second color subshape is extended.

15. A system comprising at least one computer processor and at least one non-transitory memory device operably connected to the at least one computer processor, the at least one non-transitory memory device including at least one non-transitory computer readable storage medium, the at least one memory device including computer instructions configured to cause the at least one computer processor to prepare an integrated circuit (IC) layout design by:
receiving a layout of the layout design with pattern features in the layout specified as discrete shapes;
building a multiple color representation of the layout including a combination of a plurality of colors, each color representing a respective exposure, and each discrete shape of the layout including a subshape in at least one of the colors;
determining whether the multiple color representation of the layout passes a plurality of design rules including at least a minimum space between facing vertices of adjacent shapes; and
responsive to failure under at least one design rule, adjusting the layout and repeating the building of a multiple color representation and the determining whether the multiple color representation passes a plurality of design rules.

16. The system of claim 15, wherein coincident edges of a pair of subshapes in which one subshape is a first color corresponding to a first exposure and another subshape is a second color corresponding to a second exposure indicates that the respective pair of subshapes requires additional process compensation.

17. The system of claim 16, wherein the additional process compensation includes extending one of the respective subshapes to lengthen the corresponding coincident edge.

18. The system of claim 17, wherein the second color subshape is extended.

19. The system of claim 15, wherein an intersection of edges of a pair of subshapes in which one subshape is a first color and another subshape is a second color indicates that the respective pair of subshapes requires additional process compensation.

20. The system of claim 19, wherein the additional process compensation includes extending the second color subshape to lengthen the respective intersecting edge.
